(19) United States
(12) Patent Application Publication
(10) Pub. No.: US 2025/0245731 A1
(43) Pub. Date: Jul. 31, 2025

(54) SYSTEMS AND METHODS FOR CONVERSATION BASED PRODUCT SEARCH

(71) Applicant: Walmart Apollo, LLC, Bentonville, AR (US)

(72) Inventors: Ali Arsalan Yaqoob, Union City, CA (US); Rahul Radhakrishnan Iyer, Sunnyvale, CA (US); Shubham Gupta, San Jose, CA (US); Hyun Duk Cho, San Francisco, CA (US); Praveenkumar Kanumala, Newark, CA (US); Sushant Kumar, San Jose, CA (US); Kannan Achan, Saratoga, CA (US)

(21) Appl. No.: 19/025,793

(22) Filed: Jan. 16, 2025

Related U.S. Application Data
(60) Provisional application No. 63/627,270, filed on Jan. 31, 2024.

(51) Int. Cl. G06Q 30/0601

(52) U.S. Cl. CPC G06Q 30/0633; G06Q 30/0625; G06Q 30/0641

(57) ABSTRACT

Systems and methods for performing product search based on conversations with customers are disclosed. In some embodiments, a disclosed method includes: receiving, from a computing device, a search request identifying a query and contextual information; determining, using a natural language model, at least one query entity based on the query and the contextual information; generating at least one enhanced query based on the at least one query entity and an enhancement phrase; searching a database to identify a set of items using at least one machine learning model based on the at least one enhanced query; generating a ranked list of items based on the set of items; and transmitting, to the computing device, the ranked list of items in response to the search request.

### CROSS-REFERENCE TO RELATED APPLICATION

This application claims benefit to U.S. Provisional Application Ser. No. 63/627,270, entitled “SYSTEMS AND METHODS FOR CONVERSATION BASED PRODUCT SEARCH,” filed on Jan. 31, 2024, the disclosure of which is incorporated herein by reference in its entirety.

### TECHNICAL FIELD

This application relates generally to product search and, more particularly, to systems and methods for performing product search based on conversations with customers.

### BACKGROUND

The purchase of products via online retailers has become mainstream, which has allowed customers to order an increasing number of products online and receive direct shipments of the items they order. To find a product to purchase, a customer typically accesses a retailer through Internet and submits a query online. Then, a search engine of the retailer may return search results matching the query.

But existing search and discovery systems do not always provide accurate and helpful product suggestions, because these systems fail to consider why behind a customer's search and some contextual information behind the customer's search. In addition, these systems require a customer to do heavy research to know what products or product types to search for. While conversational shopping based on a chatbot will have a huge impact on e-commerce, most customers are still unable to figure out the correct products or product types to search for, at least partially due to the dramatically huge size of a retailer's product pool nowadays. As such, it is desirable to have a conversation-based item discovery system that can avoid the above drawbacks.

### SUMMARY

The embodiments described herein are directed to systems and methods for performing product search based on conversations with customers.

In various embodiments, a system including a non-transitory memory configured to store instructions thereon and at least one processor is disclosed. The at least one processor is operatively coupled to the non-transitory memory and configured to read the instructions to: receive, from a computing device, a search request identifying a query and contextual information; determine, using a natural language model, at least one query entity based on the query and the contextual information; generate at least one enhanced query based on the at least one query entity and an enhancement phrase; search a database to identify a set of items using at least one machine learning model based on the at least one enhanced query; generate a ranked list of items based on the set of items; and transmit, to the computing device, the ranked list of items in response to the search request.

In various embodiments, a computer-implemented method is disclosed. The computer-implemented method includes: receiving, from a computing device, a search request identifying a query and contextual information; determining, using a natural language model, at least one query entity based on the query and the contextual information; generating at least one enhanced query based on the at least one query entity and an enhancement phrase; searching a database to identify a set of items using at least one machine learning model based on the at least one enhanced query; generating a ranked list of items based on the set of items; and transmitting, to the computing device, the ranked list of items in response to the search request.

In various embodiments, a non-transitory computer readable medium having instructions stored thereon is disclosed. The instructions, when executed by at least one processor, cause at least one device to perform operations including: receiving, from a computing device, a search request identifying a query and contextual information; determining, using a natural language model, at least one query entity based on the query and the contextual information; generating at least one enhanced query based on the at least one query entity and an enhancement phrase; searching a database to identify a set of items using at least one machine learning model based on the at least one enhanced query; generating a ranked list of items based on the set of items; and transmitting, to the computing device, the ranked list of items in response to the search request.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured for performing product search based on conversations with customers, in accordance with some embodiments of the present teaching;

FIG. 2 is a block diagram of an item recommendation computing device, in accordance with some embodiments of the present teaching;

FIG. 3 is a block diagram illustrating various portions of a system for performing product search based on conversations with customers, in accordance with some embodiments of the present teaching;

FIG. 4 illustrates various portions of an item recommendation computing device, in accordance with some embodiments of the present teaching;

FIG. 5 illustrates an exemplary process for performing product search based on conversations with customers, in accordance with some embodiments of the present teaching;

FIG. 6 illustrates an exemplary conversation between a customer and a chatbot, in accordance with some embodiments of the present teaching;

FIG. 7 illustrates an exemplary process for generating query entities and query entity groups, in accordance with some embodiments of the present teaching;

FIG. 8 illustrates an exemplary method for grouping query entities, in accordance with some embodiments of the present teaching;

FIG. 9 illustrates an exemplary process for encoding a query to an embedding vector, in accordance with some embodiments of the present teaching;

FIG. 10 illustrates an exemplary process for generating enhanced queries, in accordance with some embodiments of the present teaching;

FIG. 11 illustrates an exemplary process for generating an enhancement phrase for query entity enhancement, in accordance with some embodiments of the present teaching;

FIG. 12 illustrates an exemplary process for generating item recommendation carousels, in accordance with some embodiments of the present teaching;

FIG. 13 illustrates an exemplary process for increasing diversity of item recommendation carousels, in accordance with some embodiments of the present teaching;

FIG. 14 illustrates another exemplary process for increasing diversity of item recommendation carousels, in accordance with some embodiments of the present teaching;

FIG. 15 is a flowchart illustrating an exemplary method for performing product search based on conversations with customers, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

Chatbots are conversational applications that often plug into other applications and services (e.g., virtual personal assistants, schedulers, reminders, ordering systems, retail websites etc.). These chatbots provide users a communication interface to these other applications and services, aiming to provide an interaction that mimics an experience of interacting with a real person, and become more and more popular in e-commerce to enable a conversational shopping, i.e. conversation-based shopping.

One objective of various embodiments in the present teaching is to utilize natural language and customer-provided conversational context to create a streamlined and intuitive product discovery process. This offers a personalized search capability enabling customers to do product search without knowing exactly what products or product types to search for. For example, a customer can simply state: “I am a 30-year-old man looking for clothes to wear as a guest at a wedding.” That is, the customer here only knows about the context of the shopping (30-year-old man, wedding guest, clothes), but does not know exactly what to shop for. A disclosed system will determine the correct product types for the customer and search for products accordingly and automatically.

In some embodiments, the disclosed system utilizes a discovery assistant powered by a large language model (LLM), to bridge the gap between a customer's needs and the right product discovery. The LLM's ability of parsing through natural language as well as understanding context is utilized to predict product types to search for given a retailer's product pool. LLMs are proficient in interpreting natural language, enabling them to not only understand a search query but also ask questions to clarify the search context. This nuanced understanding is crucial when customers have a clear context or reason for their search but do not know the exact products they are looking for or discovering.

In some embodiments, one or more filtering and/or review processes may be implemented at various stages to identify and/or prevent generation of undesirable content by LLM or any other model. For example, one or more filtering processes may be applied to identify, remove, and/or otherwise eliminate undesirable content such as inappropriate content, offensive images, restricted images, etc. Although specific embodiments are discussed herein, it will be appreciated that any suitable filtering may be applied at any suitable steps of the disclosed methods.

In some embodiments, a chatbot in the disclosed system maintains within-chat-context of a same user. For example, a user may first ask for wedding clothes with a blue color theme. Then the same user can ask for ties and bowties. The chatbot will be able to maintain the context of blue color theme and suggest ties and bowties which match that context. The system may perform further operations to generate a ranked list of recommended items related to the suggested ties and bowties.

In some embodiments, a disclosed system determines query entities suggested by a chatbot based on its conversation with a customer. The system can dynamically merge the query entities together based on their similarity to each other and/or an LLM. The system can also extract facets and keywords associated with an item to enhance item understanding, search experience and personalization, and generate enhanced queries, which may or may be based on LLMs. In some embodiments, the system may use embeddings to search for relevant items based on the enhanced queries. The relevant items can be diversified and personalized to generate a final recommended set, which may be presented in one or more carousels. In some embodiments, a title is generated in real-time for each carousel based on carousel content and chat context.

In some embodiments, a feedback loop is formed from user engagement (e.g. interaction data like click, add-to-cart and transaction) to personalize the items to be shown to customers. This allows the customer to interact and chat to eventually discover products that will be most relevant for them, while maintaining the conversational context.

Furthermore, in the following, various embodiments are described with respect to systems and methods for performing product search based on conversations with customers are disclosed. In some embodiments, a disclosed method includes: receiving, from a computing device, a search request identifying a query and contextual information; determining, using a natural language model, at least one query entity based on the query and the contextual information; generating at least one enhanced query based on the at least one query entity and an enhancement phrase; searching a database to identify a set of items using at least one machine learning model based on the at least one enhanced query; generating a ranked list of items based on the set of items; and transmitting, to the computing device, the ranked list of items in response to the search request.

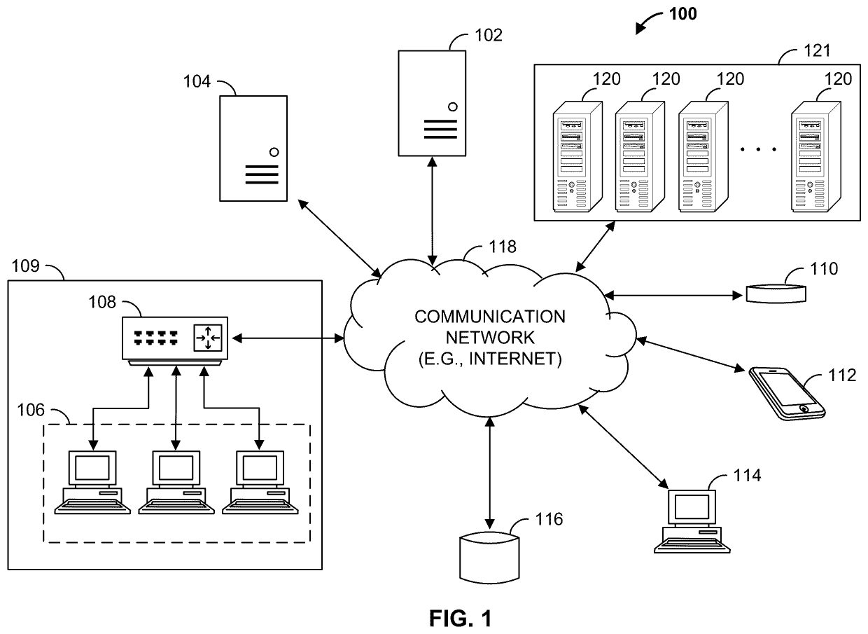

Turning to the drawings, FIG. 1 is a network environment 100 configured for performing product search based on conversations with customers, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, an item recommendation computing device 102, a server 104 (e.g., a web server or an application server), a cloud-based engine 121 including one or more processing devices 120, workstation(s) 106, a database 116, and one or more user computing devices 110, 112, 114 operatively coupled over the network 118. The item recommendation computing device 102, the server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the item recommendation computing device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the item recommendation computing device 102.

In some examples, each of the multiple user computing devices 110, 112, 114 can be a cellular phone, a smart phone, a tablet, a personal assistant device, a voice assistant device, a digital assistant, a laptop, a computer, a laser-based code scanner, or any other suitable device. In some examples, the server 104 hosts one or more websites or apps providing one or more products or services. In some examples, the item recommendation computing device 102, the processing devices 120, and/or the server 104 are operated by a retailer, and the multiple user computing devices 110, 112, 114 are operated by customers, associates and/or managers of the retailer. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a store 109 of a retailer, for example. The workstation(s) 106 can communicate with the item recommendation computing device 102 over the communication network 118. The workstation(s) 106 may send data to, and receive data from, the item recommendation computing device 102. For example, the workstation(s) 106 may transmit data identifying items purchased by a customer at the store 109 to the item recommendation computing device 102. The workstation(s) 106 may also transmit other data related to the store 109 to the item recommendation computing device 102.

Although FIG. 1 illustrates three user computing devices 110, 112, 114, the network environment 100 can include any number of user computing devices 110, 112, 114. Similarly, the network environment 100 can include any number of the item recommendation computing devices 102, the processing devices 120, the workstations 106, the servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the server 104 over the communication network 118. For example, each of the multiple user computing devices 110, 112, 114 may be operable to view, access, and interact with a website, such as a retailer's website, hosted by the server 104. The server 104 may transmit user session data related to a customer's activity (e.g., interactions) on the website. For example, a customer may operate one of the user computing devices 110, 112, 114 to initiate a web browser that is directed to the website hosted by the server 104. The customer may, via the web browser, search for items, view item advertisements for items displayed on the website, and click on item advertisements and/or items in the search result, for example. The website may capture these activities as user session data, and transmit the user session data to the item recommendation computing device 102 over the communication network 118. The website may also allow the operator to add one or more of the items to an online shopping cart, and allow the customer to perform a “checkout” of the shopping cart to purchase the items. In some examples, the server 104 transmits purchase data identifying items the customer has purchased from the website to the item recommendation computing device 102.

In some examples, the item recommendation computing device 102 may execute one or more models (e.g., programs or algorithms), such as a machine learning model, deep learning model, statistical model, etc., to generate a ranked list of recommended items. The item recommendation computing device 102 may generate and transmit the ranked list of recommended items to the server 104 over the communication network 118, and the server 104 may display one or more of the recommended items on the website to the customer. For example, the server 104 may display the recommended items to the customer on a homepage, a catalog webpage, an item webpage, a window or interface of a chatbot, a search results webpage, or a post-transaction webpage of the website (e.g., as the customer browses those respective webpages).

In some examples, the server 104 transmits a search request to the item recommendation computing device 102. The search request may be sent together with a search query provided by the customer (e.g., via a search bar of the web browser, or via a conversational interface of a chatbot), or a standalone search request provided by a processing unit in response to the user's action on the website, e.g. interacting (e.g., engaging, clicking, or viewing) with one or more items, adding one or more items to cart, purchasing one or more items, opening or refreshing a homepage. In some examples, the search request is also sent together with some contextual information.

In one example, a customer has a conversation with a chatbot hosted by the server 104, e.g. talking about a party the customer will attend in a near future. The customer may then ask the chatbot to recommend what to wear for that party. The server 104 may send a search request to the item recommendation computing device 102. For example, the chatbot may treat the question asked by the customer as a user query, and call a language model, e.g. a natural language model or a large language model, to determine a query entity based on the user query and contextual information of the conversation. In some embodiments, the language model is called by the item recommendation computing device 102 to determine the query entity, which include suggested products or product types based on the conversation with the customer. The item recommendation computing device 102 may execute one or more processors to search a product database of a retailer to generate a ranked list of recommended items based on these suggested products or product types. The item recommendation computing device 102 may transmit some or all of the recommended items to the server 104 to be displayed to the customer, e.g. via a user interface of the chatbot.

In another example, the same customer may continue to ask “what to bring as a gift?” In this case, the chatbot can utilize the conversational context of this question and understand the customer is asking what to bring as a gift for that party the customer will attend in the near future. This question will be treated as a user query to generate suggested query entities based on the context understanding. The item recommendation computing device 102 may search the product database to generate a ranked list of recommended items based on these suggested query entities and transmit some or all of the recommended items to the server 104 to be displayed to the customer, e.g. via the user interface of the chatbot.

In yet another example, the customer may be interested in one item in the recommended items displayed on the user interface, but want to twist it a little bit. For example, the customer may click on the item which may be a red bag, and ask “is there a blue version?” The chatbot can utilize the interaction data of the customer to understand the customer is asking for a blue bag that is similar to the clicked red bag. This question will be treated as a user query to generate suggested query entities based on the interaction understanding. The item recommendation computing device 102 may search the product database to generate a ranked list of recommended items based on the suggested query entities and transmit some or all of the recommended items to the server 104 to be displayed to the customer, e.g. via the user interface of the chatbot. This process can go on as the customer may select one of the newly recommended items as a reference and submit a new query or a new question associated with the newly selected item, to look for another item.

In some embodiments, the item recommendation computing device 102 is further operable to communicate with the database 116 over the communication network 118. For example, the item recommendation computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the item recommendation computing device 102, in some examples, the database 116 can be a local storage device, such as a hard drive, a non-volatile memory, or a USB stick. The item recommendation computing device 102 may store online purchase data received from the server 104 in the database 116. The item recommendation computing device 102 may receive in-store purchase data and store related data from the store 109 and store them in the database 116. The item recommendation computing device 102 may also receive from the server 104 user session data identifying events associated with browsing sessions, and may store the user session data in the database 116.

In some examples, the item recommendation computing device 102 generates and/or updates different models (e.g., machine learning models, deep learning models, statistical models, algorithms, etc.) for performing product search based on conversations with customers. The item recommendation computing device 102 may generate training data for the models based on historical user session data, purchase data, search data, conversation data and/or interaction label data. The item recommendation computing device 102 trains the models based on their corresponding training data, and stores the models in a database, such as in the database 116 (e.g., a cloud storage). The models, when executed by the item recommendation computing device 102, allow the item recommendation computing device 102 to determine recommended items.

In some examples, the item recommendation computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the item recommendation computing device 102 may generate a ranked list of recommended items.

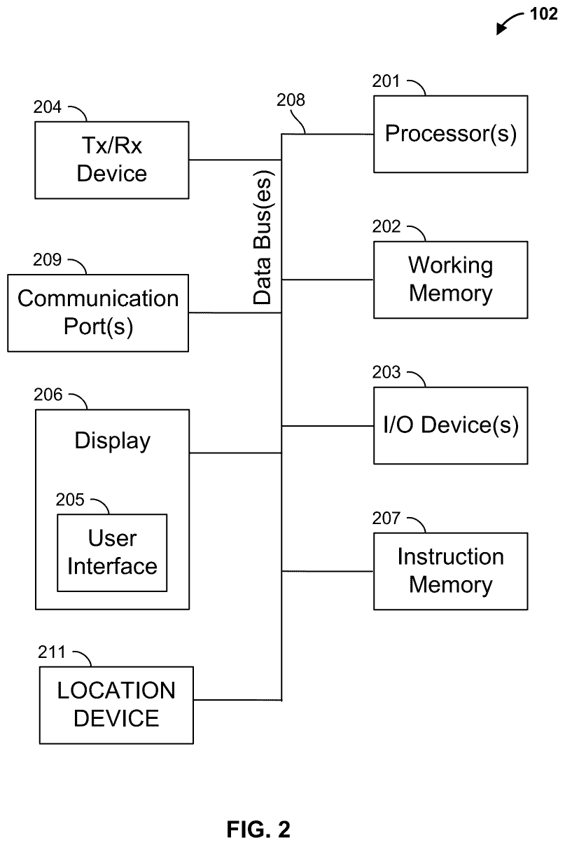

FIG. 2 illustrates a block diagram of an item recommendation computing device, e.g. the item recommendation computing device 102 of FIG. 1, in accordance with some embodiments of the present teaching. In some embodiments, each of the item recommendation computing device 102, the server 104, the workstation(s) 106, the multiple user computing devices 110, 112, 114, and the one or more processing devices 120 in FIG. 1 may include the features shown in FIG. 2. Although FIG. 2 is described with respect to certain components shown therein, it will be appreciated that the elements of the item recommendation computing device 102 can be combined, omitted, and/or replicated. In addition, it will be appreciated that additional elements other than those illustrated in FIG. 2 can be added to the item recommendation computing device 102.

As shown in FIG. 2, the item recommendation computing device 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the item recommendation computing device 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 are configured to implement an operating system (OS) and/or various applications. Examples of an OS include, for example, operating systems generally known under various trade names such as Apple macOS™, Microsoft Windows™, Android™, Linux™ and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can be configured to perform a certain function or operation by executing code, stored on the instruction memory 207, embodying the function or operation. For example, the one or more processors 201 can be configured to execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the item recommendation computing device 102 can include a single memory unit configured to operate as both instruction memory and working memory. Further, although embodiments are discussed herein including non-volatile memory, it will be appreciated that the item recommendation computing device 102 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C #, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 is configured to allow communications with the cellular network. In some embodiments, the transceiver 204 is selected based on the type of the communication network 118 the item recommendation computing device 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the item recommendation computing device 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 are configured to couple the item recommendation computing device 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 are configured to utilize one or more communication protocols. Examples of wired protocols can include, but are not limited to, Universal Serial Bus (USB) communication, RS-232, RS-422, RS-423, RS-485 serial protocols, Fire Wire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the item recommendation computing device 102 and/or the server 104. For example, the user interface 205 can be a user interface for an application of a network environment operator that allows a customer to view and interact with the operator's website. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device configured to receive position data identifying a latitude and longitude from one or more satellites of a GPS constellation. As another example, in some embodiments, the location device 211 is a cellular device configured to receive location data from one or more localized cellular towers. Based on the position data, the item recommendation computing device 102 may determine a local geographical area (e.g., town, city, state, etc.) of its position.

In some embodiments, the item recommendation computing device 102 is configured to implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

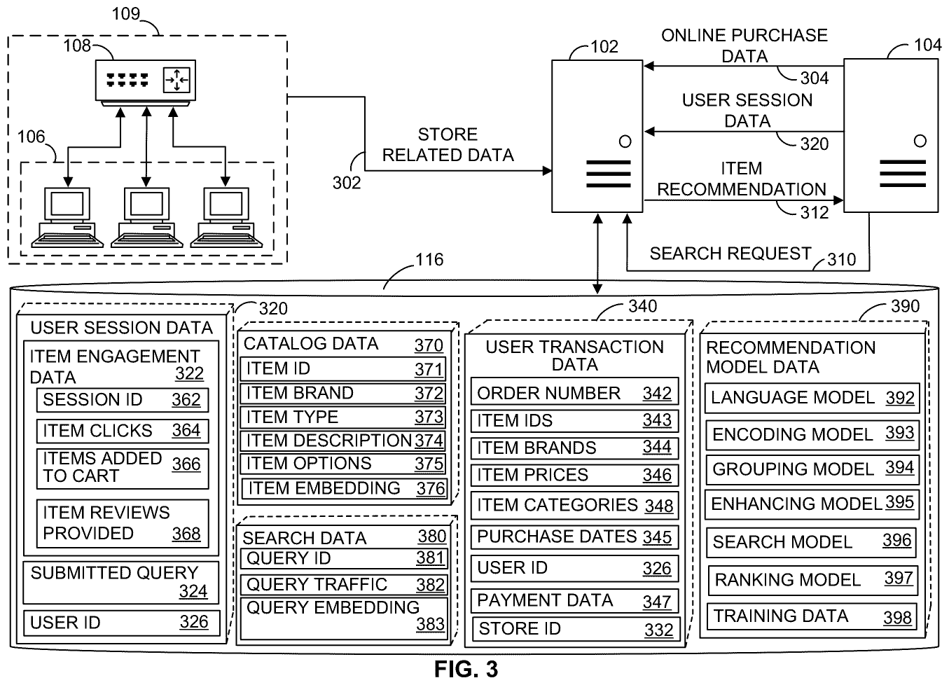

FIG. 3 is a block diagram illustrating various portions of a system for performing product search based on conversations with customers, e.g. the system shown in the network environment 100 of FIG. 1, in accordance with some embodiments of the present teaching. As indicated in FIG. 3, the item recommendation computing device 102 may receive user session data 320 from the server 104, and store the user session data 320 in the database 116. The user session data 320 may identify, for each user (e.g., customer), data related to that user's browsing session, such as when browsing a retailer's webpage hosted by the server 104.

In some examples, the user session data 320 may include item engagement data 322, submitted query data 324, and user ID 326 (e.g., a customer ID, retailer website login ID, a cookie ID, etc.). The item engagement data 322 may include one or more of a session ID 362 (i.e., a website browsing session identifier), item clicks 364 identifying items which a user clicked, items added-to-cart 366 identifying items added to the user's online shopping cart, and item reviews provided 368 identifying item reviews a user provided on the website. The submitted query data 324 may identify one or more searches conducted by a user during a browsing session (e.g., a current browsing session).

The item recommendation computing device 102 may also receive online purchase data 304 from the server 104, which identifies and characterizes one or more online purchases, such as purchases made by the user and other users via a retailer's website hosted by the server 104. The item recommendation computing device 102 may also receive store related data 302 from the store 109, which identifies and characterizes one or more in-store purchases. In some embodiments, the store related data 302 may also indicate other information about the store 109.

The item recommendation computing device 102 may parse the store related data 302 and the online purchase data 304 to generate user transaction data 340. In this example, the user transaction data 340 may include, for each purchase, one or more of: an order number 342 identifying a purchase order, item IDs 343 identifying one or more items purchased in the purchase order, item brands 344 identifying a brand for each item purchased, item prices 346 identifying the price of each item purchased, item categories 348 identifying a product type (or category) of each item purchased, purchase dates 345 identifying the purchase dates of the purchase orders, a user ID 326 for the user making the corresponding purchase, payment data 347 indicating payment methods and related information (e.g. emails associated with payment) for corresponding online orders, and store ID 332 for the corresponding in-store purchase, or for the pickup store or shipping-from store associated with the corresponding online purchase.

In some embodiments, the database 116 may further store catalog data 370, which may identify one or more attributes of a plurality of items, such as a portion of or all items a retailer carries in stores and/or at e-commerce platforms. The catalog data 370 may identify, for each of the plurality of items, an item ID 371 (e.g., an SKU number), item brand 372, item type 373 (e.g., grocery item such as milk, clothing item), item description 374 (e.g., a description of the product including product features, such as ingredients, benefits, use or consumption instructions, or any other suitable description), item options 375 (e.g., item colors, sizes, flavors, etc.), and item embedding 376 representing the item in a vector space.

The database 116 may also store search data 380, which may identify one or more features of a plurality of queries submitted by users on the website. The search data 380 may include, for each of the plurality of queries, a query ID 381 identifying a query previously submitted by users, query traffic data 382 identifying how many times the query has been submitted or how many clicks the query has received, and query embedding data 383 identifying an embedding representing the query in a vector space.

The database 116 may also store recommendation model data 390 identifying and characterizing one or more models and related data for performing product search based on conversations with customers. For example, the recommendation model data 390 may include: a language model 392, an encoding model 393, a grouping model 394, an enhancing model 395, a search model 396, a ranking model 397, and training data 398.

The language model 392 may include a natural language model or a large language model, which is used to understand customer intent based on a conversation with a customer, and/or to achieve any other general-purpose language understanding and generation. In general, a large language model (LLM) can acquire these abilities by learning statistical relationships from text documents during a computationally intensive self-supervised and semi-supervised training process. In some examples, LLMs are artificial neural networks following a transformer architecture. In some embodiments, the language model 392 is used to determine at least one query entity based on a query and contextual information submitted by a customer in a conversation with a chatbot. Each query entity may be a suggested product, product type or product category based on the general-purpose language understanding of the query and the contextual information.

In some embodiments, the encoding model 393 may be used to encode a query or a product item into an embedding. In some examples, the encoding model 393 is used to transform the name of each product item into an item embedding vector in a vector space. In some examples, the encoding model 393 is used to transform each query entity name (which may be a product name, product type name, product category name, product family name, or product department name) into an embedding vector in the vector space. In some examples, the encoding model 393 is used to transform the text of a query into a query embedding vector in the vector space as well. These vectors can help to better understand and process human language for item search and discovery.

The grouping model 394 may be used to group multiple query entities (e.g. product) into a group. In some embodiments, the grouping model 394 is used to compare embedding vectors of two query entities and determine a similarity score between the two query entities. If the similarity score is larger than a predetermined threshold, the two query entities are grouped into a same group to be potentially displayed together to a customer. In some embodiments, the grouping model 394 includes an LLM configured to determine whether two query entities should be organized into a same group for display or not.

The enhancing model 395 may be used to generate an enhanced query, e.g. based on each query entity and an enhancement phrase. In some embodiments, the enhancement phrase is generated based on intersecting word tokens between the original user query and product type names that are similar to the user query based on embedding based similarity scores. In some embodiments, the enhancement phrase is generated based on an LLM configured to extract essential product facets and features for forming the enhancement phrase.

The search model 396 may be used to search a database to identify a set of items based on a given query or enhanced query. In some embodiments, the search model 396 includes a predictive model trained based on customer transaction patterns. In some examples, the predictive model maps most commonly searched queries to products that would most likely be purchased by customers after submitting the corresponding queries. Each of the most commonly searched queries can be converted to a vector embedding by the encoding model 393. The search model 396 can compare these vector embeddings with an embedding of the enhanced query to determine, among the most commonly searched queries, a most similar query to the enhanced query. In some embodiments, a nearest neighbor index can be utilized in the vector embedding database for fast search and retrieval. The search model 396 can then map the most similar query back to a set of product items that are most likely be purchased by customers. The set of product items can be identified as search results for the given query or enhanced query.

The ranking model 397 may be used to organize and rank the product items identified by the search model 396 to generate at least one ranked list of recommended items. In some examples, the recommended items are presented in carousels, and each carousel includes items recommended for a corresponding enhanced query generated by the enhancing model 395 and a corresponding group generated by the grouping model 394. In some embodiments, the recommended items in each carousel are organized and ranked to increase product diversity, to ensure an equal representation of different suggested products in the carousel. In some embodiments, the recommended items in each carousel are also organized and ranked to increase product type diversity. In one example, when a carousel only has one product type, similar items of different product types are added into the carousel. In another example, when there are multiple product types in one carousel, the items are re-ordered to ensure an equal representation of different product types in the carousel. As such, each carousel includes a ranked list of items in one or more product types and may have a carousel title generated based on all of the one or more product types.

The training data 398 may include data utilized for training one or more of the language model 392, the encoding model 393, the grouping model 394, the enhancing model 395, the search model 396, and the ranking model 397. In some examples, the training data 398 may include, but not limited to, data related to a plurality of customers, their historical transaction data, user session data, search data, and interaction based label data. For example, the interaction based label data may be determined based on historical interactions of the customers regarding ranked items recommended to them in response to their corresponding submitted queries. In some examples, the training data 398 may be used to train a machine learning model to optimize an objective function based on optimized hyperparameters. In some examples, the training data 398 is updated based on feedback data from the customers regarding the recommended items.

In some examples, the item recommendation computing device 102 receives a search request 310 from the server 104. The search request 310 may be associated with a query and contextual information obtained from a conversation with a customer. In some embodiments, the item recommendation computing device 102 may determine at least one query entity based on the query and the contextual information. Based on the at least one query entity and an enhancement phrase, the item recommendation computing device 102 may generate at least one enhanced query, and search a database to identify a set of items using at least one machine learning model based on the at least one enhanced query. The at least one machine learning model may include any model in the recommendation model data 390. A ranked list of items may be generated based on the set of items to serve as item recommendation 312. In response to the search request 310, the item recommendation computing device 102 transmits the item recommendation 312 to the server 104.

In some embodiments, the item recommendation computing device 102 may assign one or more of the above described operations to a different processing unit or virtual machine hosted by one or more processing devices 120. Further, the item recommendation computing device 102 may obtain the outputs of the these assigned operations from the processing units, and generate the ranked list of recommended items based on the outputs.

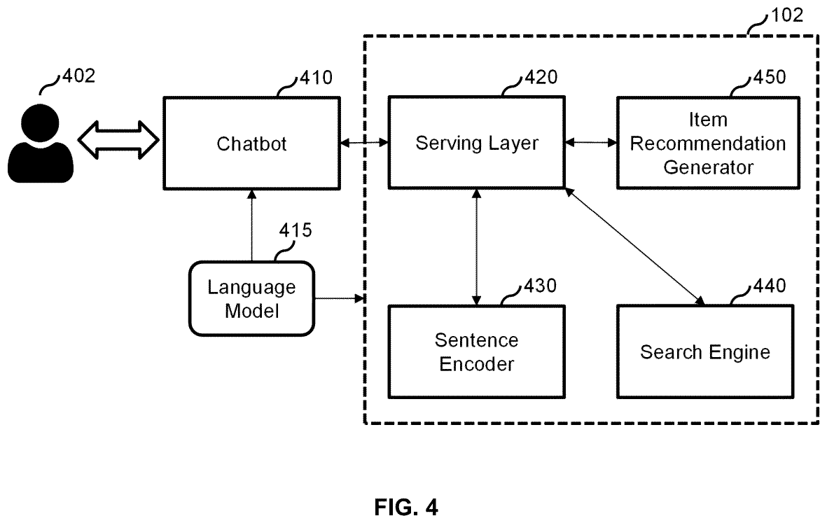

FIG. 4 is a block diagram illustrating a more detailed view of an item recommendation computing device, e.g. the item recommendation computing device 102 in FIG. 1, in accordance with some embodiments of the present teaching. As shown in FIG. 4, the item recommendation computing device 102 includes a serving layer 420, a sentence encoder 430, a search engine 440, and an item recommendation generator 450. For example, the item recommendation computing device 102 may interact with a chatbot module 410 and a language model 415. In some embodiments, the chatbot module 410 and the language model 415 may be hosted by a server, e.g. the server 104. In other embodiments, the chatbot module 410 and/or the language model 415 may also be part of the item recommendation computing device 102.

In some examples, one or more of the chatbot module 410, the serving layer 420, the sentence encoder 430, the search engine 440 and the item recommendation generator 450 are implemented in hardware. In some examples, one or more of the chatbot module 410, the serving layer 420, the sentence encoder 430, the search engine 440 and the item recommendation generator 450 are implemented as an executable program maintained in a tangible, non-transitory memory, such as instruction memory 207 of FIG. 2, which may be executed by one or processors, such as the processor 201 of FIG. 2.

As shown in FIG. 4, the chatbot module 410 may have a conversation with a customer 402. The customer 402 can just state contextual information about a plan or an event associated with a product search in the conversation, without a need to know exactly what kind of products to be searched. The chatbot module 410 can send a search request to the item recommendation computing device 102 associated with a query and contextual information of the conversation. The query may be generated based on any question asked by the customer 402, like “what to wear?” “how to decorate?” “what to bring?” etc. The item recommendation computing device 102 may receive the search request and generate item recommendations accordingly.

In some embodiments, the chatbot module 410 can determine, using the language model 415, at least one query entity based on the query and the contextual information. In some examples, the language model 415 is the language model 392 in the database 116. The chatbot module 410 then sends the at least one query entity to the item recommendation computing device 102 together with the search request. Each query entity may be a suggested product, product type, product category, product family, products of a same brand, or product department, generated based on the query and the contextual information. In some embodiments, the serving layer 420 may receive the search request from the chatbot module 410, and call the language model 415 to generate the at least one query entity.

In some embodiments, the serving layer 420 may call the sentence encoder 430, which may be a pre-trained universal sentence encoder based on machine learning, to encode the query into a query embedding vector, and generate an enhancement phrase based on the query embedding vector to enhance each query entity. In some embodiments, the sentence encoder 430 can use an encoding model, e.g. the encoding model 393 in the database 116, to encode the query into the query embedding vector, which can be compared to product embedding vectors in a same embedding space. Each of the product embedding vectors may be pre-generated by the sentence encoder 430 based on a corresponding product name in a product pool of a retailer associated with the chatbot module 410. Based on the comparison of embeddings, the serving layer 420 can use an enhancement model, e.g. the enhancing model 395 in the database 116, to generate the enhancement phrase and to generate an enhanced query based on each query entity and the enhancement phrase. For example, the enhanced query may be formed by concatenating the corresponding query entity and the enhancement phrase.

In some embodiments, the serving layer 420 may call the search engine 440 to search a database to identify a set of items based on each enhanced query. In some embodiments, the search engine 440 can use a search model, e.g. the search model 396 in the database 116, to search for product items in a product database of the retailer based on the enhanced query. In some embodiments, embeddings have been pre-generated by the sentence encoder 430 for most commonly searched queries and corresponding product items most likely to be purchased after submitting these queries in the product database of the retailer. In some examples, a nearest neighbor index, e.g. Milvus index, is created for these embeddings for fast search and retrieval of the embeddings and the corresponding items and queries. The search engine 440 can search the database using the nearest neighbor index based on the enhanced query to identify the set of items.

In some embodiments, the serving layer 420 may call the item recommendation generator 450 to generate a ranked list of recommended items based on the items identified by the search engine 440. In some embodiments, the item recommendation generator 450 can use a ranking model, e.g. the ranking model 397 in the database 116, to rank the recommended items. In some examples, the serving layer 420 can use a grouping model, e.g. the grouping model 394 in the database 116, to group query entities generated by the language model 415 into one or more carousel groups. The item recommendation generator 450 may generate a ranked list of recommended items for each carousel group. Then 420 then transmits each ranked list of recommended items to the chatbot module 410 in response to the search request. The chatbot module 410 may provide each ranked list of recommended items, e.g. as a carousel, to the customer 402 via the user interface of the chatbot module 410.

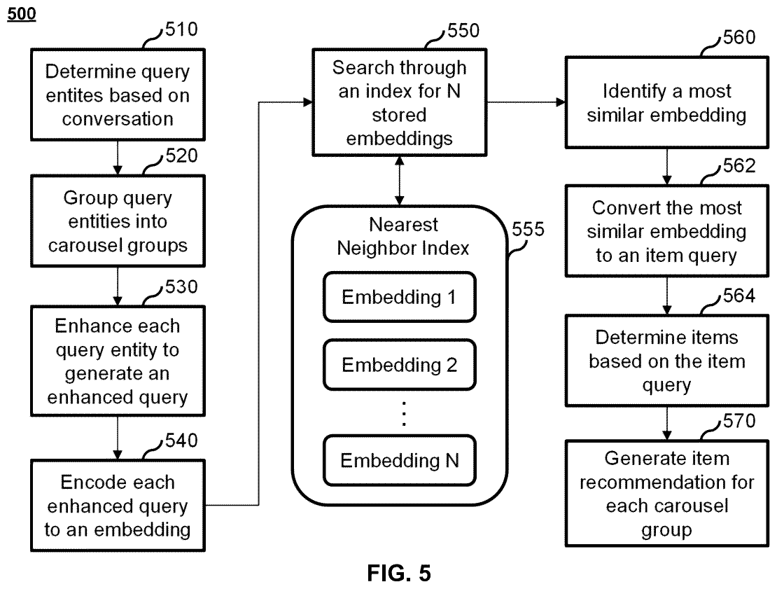

FIG. 5 illustrates an exemplary process 500 for performing product search based on conversations with customers, in accordance with some embodiments of the present teaching. In some embodiments, the process 500 can be carried out by one or more computing devices, such as the item recommendation computing device 102, the server 104, and/or the cloud-based engine 121 of FIG. 1.

As shown in FIG. 5, the process 500 starts from operation 510, where one or more query entities are determined based on a conversation with a customer. The conversation may be between the customer and a chatbot associated with a retailer. The chatbot is assisting the customer to search for and shop for products of the retailer, through the conversation. The query entities are most contextually relevant items or product types suggested by the chatbot to the customer based on the conversation.

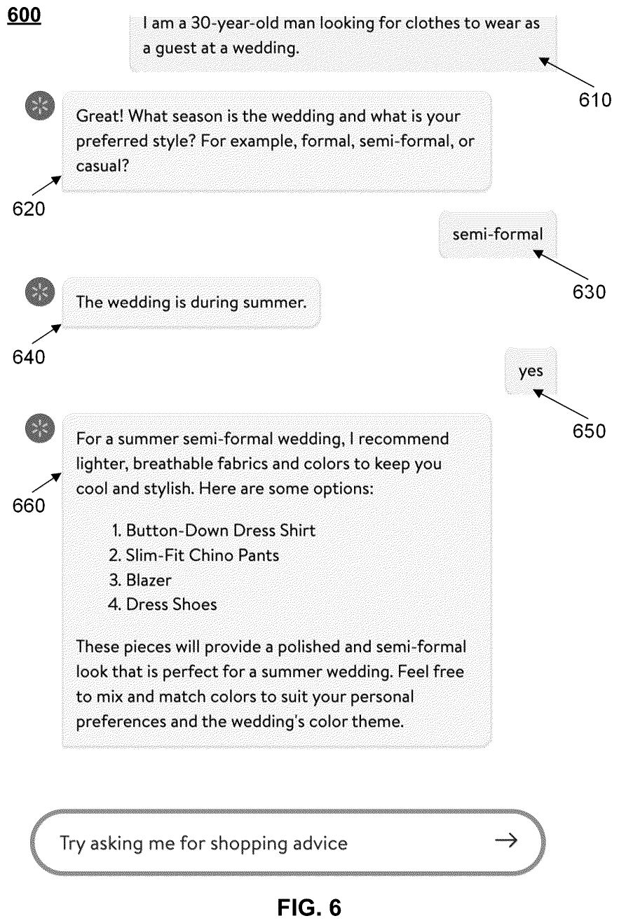

FIG. 6 illustrates an exemplary user interface 600 of a chatbot including a conversation between a customer and the chatbot, in accordance with some embodiments of the present teaching. As shown in FIG. 6, the customer inputs “I am a 30-year-old man looking for clothes to wear as a guest at a wedding” 610 via the user interface 600. The chatbot provides a response 620 asking about the season of the wedding and what style is preferred by the customer. While the customer merely answers the preferred style as “semi-formal” 630, the customer does not answer the season of the wedding in this example. The chatbot in this example directly provides a response 640 estimating the season of the wedding to be during summer, e.g. based on the date and time of the conversation. The customer then gives a confirmation 650 about the wedding season.

In the example shown in FIG. 6, the chatbot gives a recommendation response 660 including four query entity options: button-down dress shirt, slim-fit chino pants, blazer, and dress shoes, based on the conversation. In some examples, the four query entity options in FIG. 6 are four exemplary query entities determined at the operation 510 in FIG. 5. In some embodiments, the system can form a user query based on one or more of the user inputs 610, 620, 630, or based on the entire conversation including the inputs 610, 620, 630 and the responses 620, 640.

While the chatbot in FIG. 6 merely provides the suggested query entity options, the process 500 in FIG. 5 can directly generate specific recommended items based on these suggested query entity options. Referring back to FIG. 5, at operation 520, the query entities are grouped into query entity groups or carousel groups. In some examples, each carousel group will correspond to a carousel of items to be displayed to the customer. If the query entities are grouped into X groups, there will be X carousels of items (or X ranked lists of items) recommended to the customer after the process 500.

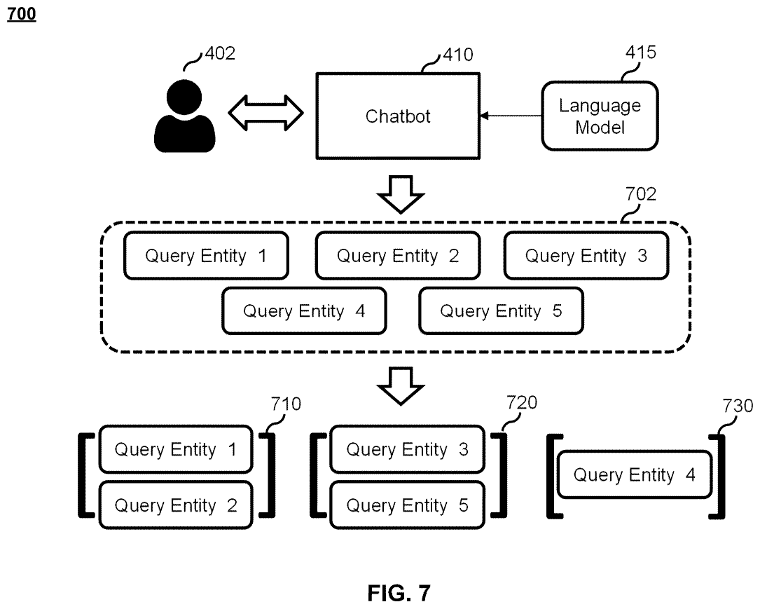

FIG. 7 illustrates an exemplary process 700 for generating query entities and query entity groups, in accordance with some embodiments of the present teaching. In some embodiments, the process 700 can be carried out by one or more computing devices, such as the item recommendation computing device 102, the server 104, and/or the cloud-based engine 121 of FIG. 1. In some embodiments, the process 700 illustrates a detailed process of the operations 510, 520 of FIG. 5.

As shown in FIG. 7, the chatbot module 410 may have a conversation with the customer 402. In some examples, the customer 402 may initiate the conversation and discovery process by submitting a query that reflects need and preference of the customer 402.

The chatbot module 410 can utilize the language model 415 to parse through the input of the customer 402, extract essential information and identify subtle nuances to comprehend the needs of the customer 402 effectively. Based on the query and the needs, the chatbot module 410 can curate a list 702 of suggested query entities, ensuring each query entity is aligned with the initial query and needs of the customer 402. In some examples, generation of the list 702 can be realized by the operation 510 in FIG. 5. In the example shown in FIG. 7, the list 702 includes five query entities. Each query entity may be a suggested product, product type, product category, product family, or product department, depending on how specific the query and the needs of the customer 402 are.

In the example shown in FIG. 7, the list 702 of five query entities is grouped into three query entity groups or carousel groups 710, 720, 730. The grouping may be based on similarity, making it easier to look through when relevant items are recommended. For example, two suggested query entities are combined into one group if they are considered similar to each other. In some examples, generation of the carousel groups 710, 720, 730 can be realized by the operation 520 in FIG. 5. In some examples, each group of query entities will be used to generate one carousel shown to the customer 402. In the example shown in FIG. 7, three carousels generated from the three carousel groups 710, 720, 730 will be shown to the customer 402, making the customer experience more pleasant and easier to navigate.

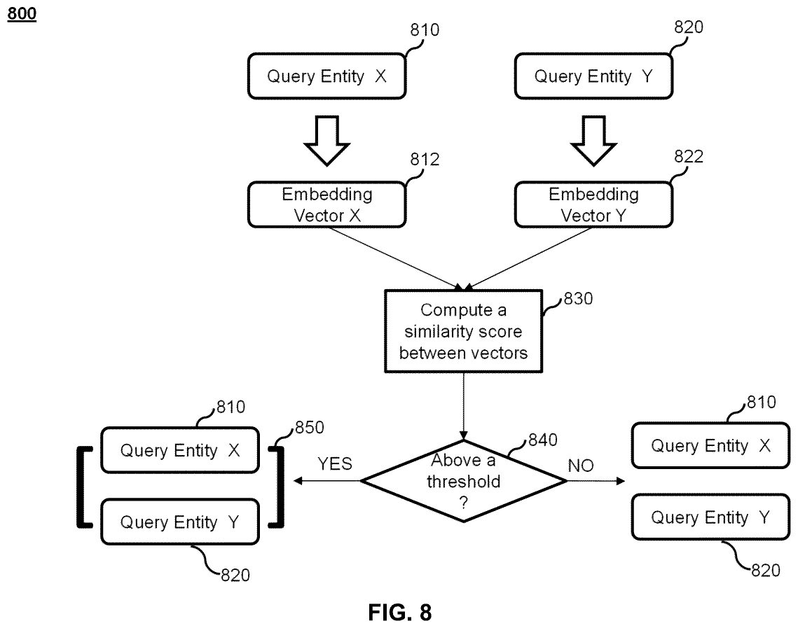

The carousel groups 710, 720, 730 can be generated based on different methods. FIG. 8 illustrates an exemplary method 800 for grouping query entities to generate carousel groups, e.g. the carousel groups 710, 720, 730 in FIG. 7, in accordance with some embodiments of the present teaching. In some embodiments, the process 800 can be carried out by one or more computing devices, such as the item recommendation computing device 102 and/or the cloud-based engine 121 of FIG. 1. In some embodiments, the process 800 illustrates a detailed process of the operation 520 of FIG. 5.

The process 800 determines whether two query entities, query entity X 810 and query entity Y 820, should be grouped together or not. These two query entities can be any two query entities, e.g. any two of the five query entities in the list 702, being concerned for grouping or not.

As shown in FIG. 8, query entity X 810 and query entity Y 820 are converted to embedding vector X 812 and embedding vector Y 822, respectively. In some examples, this conversion is to transform a name of each query entity into an embedding vector using a sentence encoder, e.g. the sentence encoder 430. In general, any textual data, like a query, a product type name or a query entity name, can be encoded into a corresponding embedding vector.

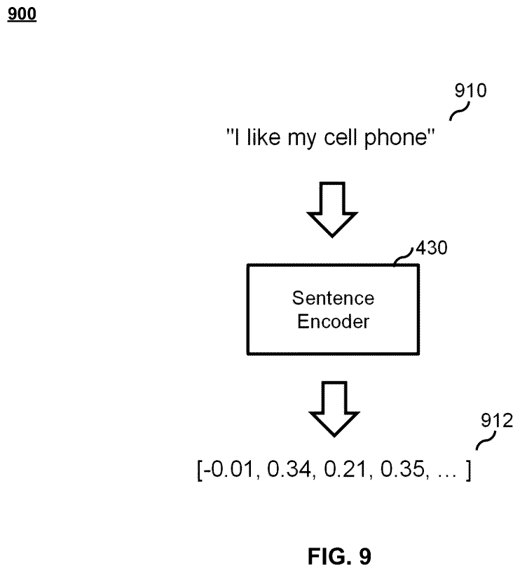

FIG. 9 illustrates an exemplary process 900 for encoding a query to an embedding vector, in accordance with some embodiments of the present teaching. In some embodiments, the process 900 can be carried out by one or more computing devices, such as the item recommendation computing device 102 and/or the cloud-based engine 121 of FIG. 1. In some embodiments, the process 900 is carried out by the sentence encoder 430 in FIG. 4.

As shown in FIG. 9, the sentence encoder 430 performs sentence embedding to transform textual data 910 into a numerical vector 912. This numerical vector 912 can help the system to better understand and process human language including the textual data 910. In some examples, the textual data 910 can be replaced by any product name or any query entity name, e.g. a name of the query entity X 810 or the query entity Y 820, to generate a corresponding embedding vector.

An embedding vector is a numerical representation that can be used to assess the semantic similarity between any two pieces of texts, even if they are unrelated to each other. The system can use measure a similarity score, e.g. based on cosine similarity or Euclidean distance, between the embedding vector representations of two texts to determine how similar they are to each other. For example, these embeddings generated following the process 900 can be used to compare the names of two products to determine if they are similar to each other and whether they can be combined into a group.

Referring back to FIG. 8, names of the query entity X 810 and the query entity Y 820 are transformed to the embedding vector X 812 and the embedding vector Y 822, respectively, based on the process 900. Each embedding vector can grasp the semantic meaning behind the query entity names.

At operation 830, a similarity score is computed between the embedding vector X 812 and the embedding vector Y 822. For example, the similarity score can be computed based on a cosine similarity between the two embedding vectors. Then at operation 840, it is determined whether the similarity score is above a predetermined threshold. If so, the query entity X 810 and the query entity Y 820 are grouped into a same carousel group 850. If not, the query entity X 810 and the query entity Y 820 are determined to be not similar and will not be grouped together.

After the process 800 is performed for the query entity X 810 and the query entity Y 820, the same process 800 can be performed for the query entity X 810 and another query entity, or for any two additional query entities being concerned for grouping. If an additional query entity is determined to be similar to a query entity in an existing carousel group, e.g. when their similarity score is above the predetermined threshold, the additional query entity is merged into the existing carousel group. In some examples, the process 800 can go on for all of the five query entities in the list 702 in FIG. 7, to generate the three carousel groups 710, 720, 730.

In some embodiments, the list 702 of query entities can be grouped into the three carousel groups 710, 720, 730 based on an LLM, e.g. the language model 415. For example, through prompt engineering, the LLM can use basic reasoning to organize the list 702 of query entities into different carousel groups, and output the three carousel groups 710, 720, 730 in a desired format. This process can be performed automatically by the chatbot module 410 or the item recommendation computing device 102 without any user or customer input.

Referring back to FIG. 5, at operation 530, each query entity is enhanced to generate an enhanced query. This enhancement may bolster queries with targeted keywords, amplify accuracy and enhance the relevance of the search results. In some embodiments, the operation 530 can be performed before the operation 520.

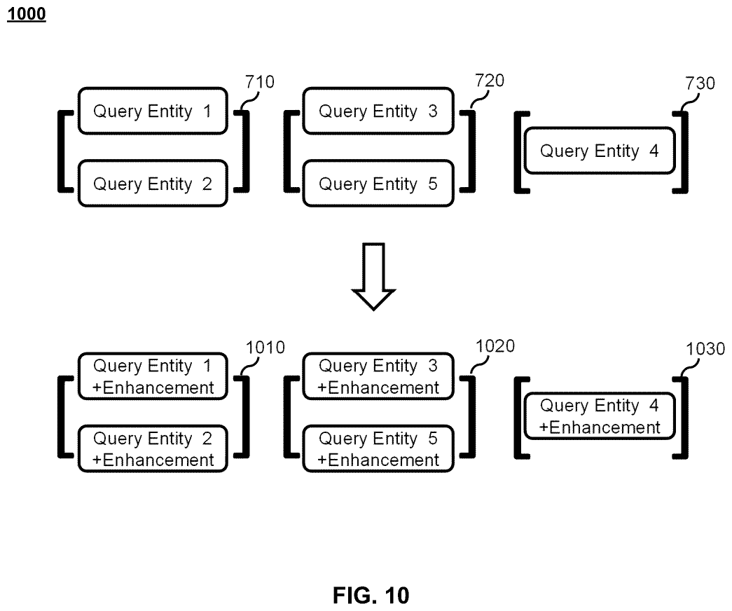

FIG. 10 illustrates an exemplary process 1000 for generating enhanced queries, in accordance with some embodiments of the present teaching. In some embodiments, the process 1000 can be carried out by one or more computing devices, such as the item recommendation computing device 102 and/or the cloud-based engine 121 of FIG. 1. In some embodiments, the process 1000 illustrates a detailed process of the operation 530 of FIG. 5.

As shown in FIG. 10, each query entity in the three carousel groups 710, 720, 730 is enhanced with an enhancement phrase to generate a corresponding enhanced query. The generated enhanced queries are still grouped according to the three carousel groups 1010, 1020, 1030 corresponding to the three carousel groups 710, 720, 730, respectively.

In general, product recommendations are enhanced when the products are supplemented with product type context. In one example, when query entity 1 in the carousel group 710 is “SSSS wh-1000xm5,” the system can determine a product type for this query entity 1 is a headphone. As such, the query entity 1 can be enhanced to be “SSSS wh-1000xm5 headphones.” This enhancement helps with searching for the product through the search database. In the example shown in FIG. 10, all query entities in the three carousel groups 710, 720, 730 are enhanced with a same enhancement phrase. In other examples, different query entities may be enhanced with different enhancement phrases, respectively.

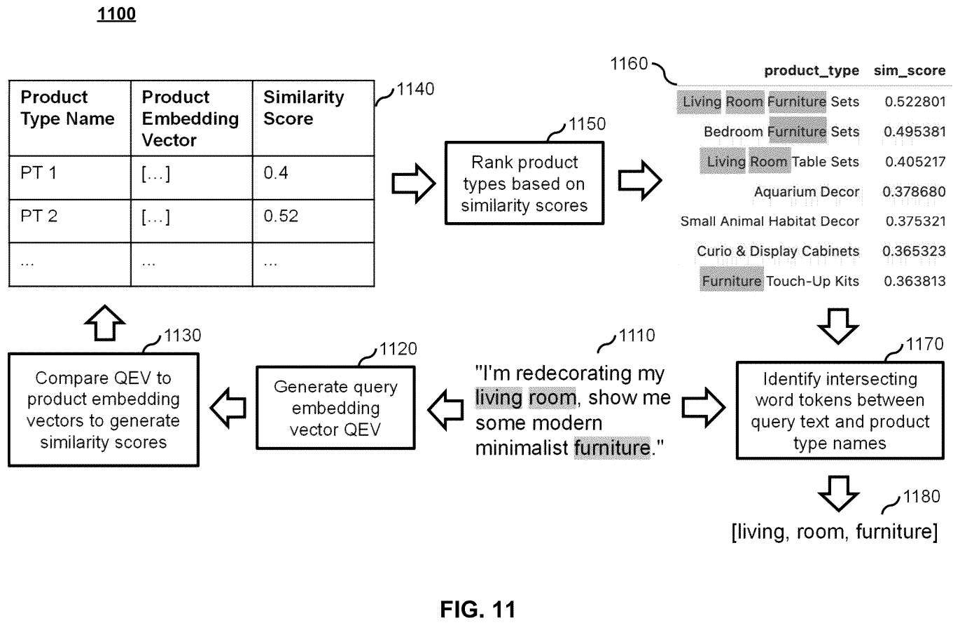

FIG. 11 illustrates an exemplary process 1100 for generating an enhancement phrase for query entity enhancement, in accordance with some embodiments of the present teaching. In some embodiments, the process 1100 can be carried out by one or more computing devices, such as the item recommendation computing device 102 and/or the cloud-based engine 121 of FIG. 1. In some embodiments, the process 1100 illustrates a detailed process for generating the enhancement phrase of the enhanced queries in the three carousel groups 1010, 1020, 1030 in FIG. 10.

In the example shown in FIG. 11, a user provided context, e.g. a query 1110, is obtained in a sentence form, e.g. from a customer via a user interface of a chatbot. At operation 1120, the query 1110 is transformed into a query embedding vector, QEV. In some embodiments, the QEV is a numerical representation generated utilizing a sentence encoder, e.g. the sentence encoder 430, based on the process 900.

At operation 1130, the QEV is compared with the embedding vector representations of the products or product types present within a retailer's catalog, to generate similarity scores. As shown in the table 1140, a product embedding vector has been generated for each product type name (PT1, PT2 . . . ) e.g. utilizing the sentence encoder 430 based on the process 900. In addition, based on the operation 1130, each product type name is also associated with a similarity score computed between its corresponding product embedding vector and the QEV. Each similarity score may be computed based on cosine similarity or Euclidean distance. A higher similarity score for a product embedding vector of a corresponding product type represents a higher similarity between the query 1110 and the corresponding product type, compared to other product types.

At operation 1150, the product types are ranked based on their respective similarity scores, i.e. based on their respective degrees of similarity to the query 1110. In an exemplary table 1160, only top ranked product types are listed. In some examples, the table 1160 can be generated by applying a certain threshold to the similarity scores and only include the top ranked product types whose similarity scores are above the threshold. The threshold can be predetermined and/or dynamically adjusted, e.g. to ensure the number of product types in the table 1160 to fall into a predetermined range.

At operation 1170, intersecting word tokens between the text of the query 1110 and the product type names in the table 1160 are identified as context which can enrich the search process. As such, these intersecting word tokens, as highlighted in the query 1110 and the table 1160, can be selected to form an enhancement phrase 1180. In some examples, each query entity generate for the query 1110 may be concatenated with the enhancement phrase 1180 to generate an enhanced query for product search. In various embodiments, the enhancement phrase 1180 can be placed before, after or in the query entity, to generate the enhanced query.

In some embodiments, the enhancement phrase of the enhanced queries in the three carousel groups 1010, 1020, 1030 in FIG. 10 can be generated based on an LLM, e.g. the language model 415. For example, through prompt engineering, the LLM can use both a user submitted query and a query entity name (e.g. determined via the operation 510 in FIG. 5) to identify and extract essential contextual product facets that will significantly enhance the search process, and output the enhancement phrase or phrase components in a desired format. This process can be performed automatically by the chatbot module 410 or the item recommendation computing device 102 without any user or customer input.

Referring back to FIG. 5, at operation 540, each enhanced query is encoded to an enhanced query embedding, e.g. using the sentence encoder 430. The enhanced query embedding will be used to search a product database of a retailer to identify matching items. The searching process includes operations 550 to 564, which can be performed by the search engine 440 according to some embodiments. In some embodiments, the search process is based on an embedding based search index and a predictive model rooted in customer transaction data.

At operation 550, the enhanced query embedding is used to search through an index for N stored embeddings. In some examples, the N stored embeddings represent N most commonly searched queries based on historical search data of the retailer.

In some embodiments, the N stored embeddings can be generated based on a predictive model that is trained using customer transaction patterns. This allows for the anticipation of customer preferences and the delivery of more aligned product suggestions. In some examples, the predictive model is used to map N most commonly searched queries to products that would most likely be purchased (or interacted with) by customers based on historical customer transactions. In some embodiments, N is a large number, e.g. millions, for an e-commerce retailer or a retail corporation.

In some examples, these N queries are each converted to an embedding vector, e.g. using the sentence encoder 430, to generate the N embeddings 555 stored in a database of the retailer, e.g. the database 116. In some examples, a nearest neighbor index, e.g. a Milvus index, is created for the N embeddings 555 stored in a vector database. The nearest neighbor index is optimized for fast search and retrieval of the N embeddings 555. The index can be used to search, at the operation 550, for products that are most relevant to a query, e.g. a customer submitted query obtained from the chatbot module 410 or an enhanced query generated by the operation 530.

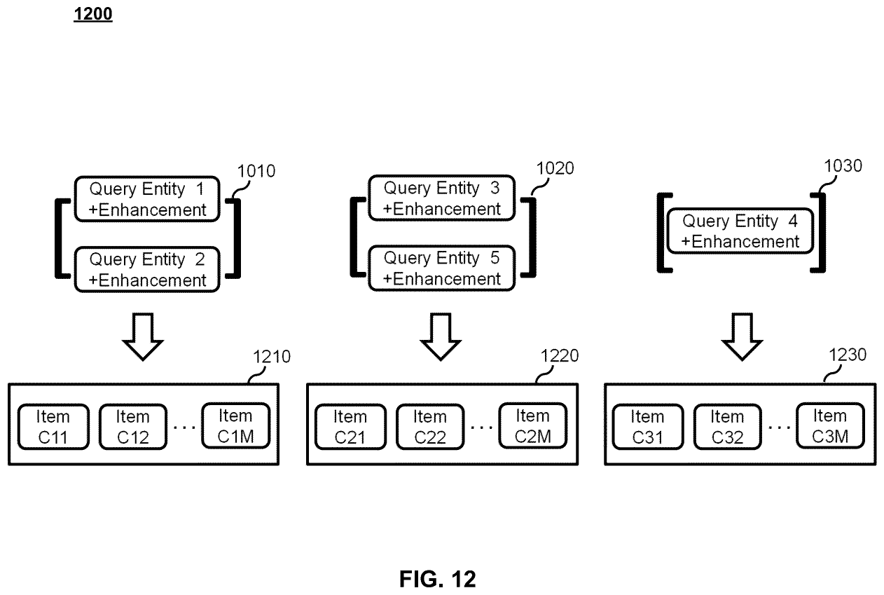

In the example shown in FIG. 5, the nearest neighbor index is used to quickly identify, at operation 560, a most similar embedding among the N stored embeddings 555 compared to the enhanced query embedding generated by the operation 540. In some embodiments, if no exact or best match can be found by searching through the search index, the results from the next best match (called nearest neighbor) are used. For example, given a query of “2% milk 5 gallon,” no product is found in the database to be 2% milk in a 5 gallon container. In this case, the search index can help to quickly identify the nearest neighbor product(s), e.g. 1% milk 5 gallon and/or 2% milk 3 gallon. As such, the most similar embedding may include one or more embedding vectors. In some embodiments, when multiple query entities are collapsed into a single group, the top results from the search index will be used to show items in a way that ensures diversity. The details will be discussed later regarding FIGS. 12-14.

At operation 562 in the process 500, the most similar embedding is converted back, e.g. by the sentence encoder 430, a decoder corresponding to the sentence encoder 430 or just based on a previously stored mapping, to a corresponding query that is one of the N most commonly searched queries. The corresponding query in this example is an item query automatically generated or determined by the system, rather than a query submitted by the customer having the conversation with the chatbot. This corresponding query represents a query the customer would potentially like to input if the customer knows what type of products to search for according to the context in the conversation between the customer and the chatbot.

The corresponding query can be used to determine at operation 564, e.g. using the predictive model which may be a probabilistic model, a set of items that would most likely be purchased by customers after submitting the corresponding query. As such, a set of items is determined for each enhanced query. In some embodiments, each item in the set of items is associated with a likelihood of purchases, which will be used for ranking or re-ordering in operation 570.

At the operation 570, an item recommendation is generated for each carousel group. When a carousel group includes multiple query entities corresponding to multiple enhanced queries, items determined for the multiple enhanced queries are combined together to generate a ranked list of recommended items at the operation 570 to be displayed to the customer in one carousel.

In some embodiments, the system emphasizes not only relevance but also diversity in the item recommendation, broadening the array of options presented to customers, and ensuring a well-rounded selection tailored to various needs and preferences of customers. In some embodiments, the operation 570 includes details processes shown in FIGS. 12-14.

FIG. 12 illustrates an exemplary process 1200 for generating item recommendation carousels, in accordance with some embodiments of the present teaching. In some embodiments, the process 1200 can be carried out by one or more computing devices, such as the item recommendation computing device 102 and/or the cloud-based engine 121 of FIG. 1. In some embodiments, the process 1200 illustrates a detailed process of the operation 570 performed by the item recommendation generator 450 for generating item recommendation carousels.

As discussed above, each query entity, along with its enhancements, is converted to its embedding representation, which is used to search for items using the nearest neighbor index. As shown in FIG. 12, items in search results for query entities belonging to a same group are combined into a single item recommendation carousal. For example, the item recommendation carousal 1210 includes items C11 . . . C1M in search results for the query entities in the group 1010; the item recommendation carousal 1220 includes items C21 . . . C2M in search results for the query entities in the group 1020; and the item recommendation carousal 1230 includes items C31 . . . C3M in search results for the query entity in the group 1030.

In some embodiments, personalization is applied to the item recommendations that result from each individual (enhanced) query which is used to search through the nearest neighbor index. Initially, the recommended items in each item recommendation carousal may be ordered or ranked based on their respective likelihood of purchases, e.g. determined based on the operation 564 in FIG. 5. In some examples, to personalize the recommended items that are shown to the customer, the system can re-order the recommended items in each item recommendation carousal based on the customer's affinity to certain brands, to certain prices, and/or to certain product types, which all may be determined via an LLM, e.g. the language model 415. In some examples, the recommended items in an item recommendation carousal can also be re-ordered based on LLM generated tags associated with certain products and/or the customer's persona. In some examples, the recommended items in a carousal can also be re-ordered to boost previously purchased items of the customer towards the beginning of the carousal. In some examples, the recommended items in a carousal can also be re-ordered based on: how long a product lasts, how fast is customer consumption, etc.

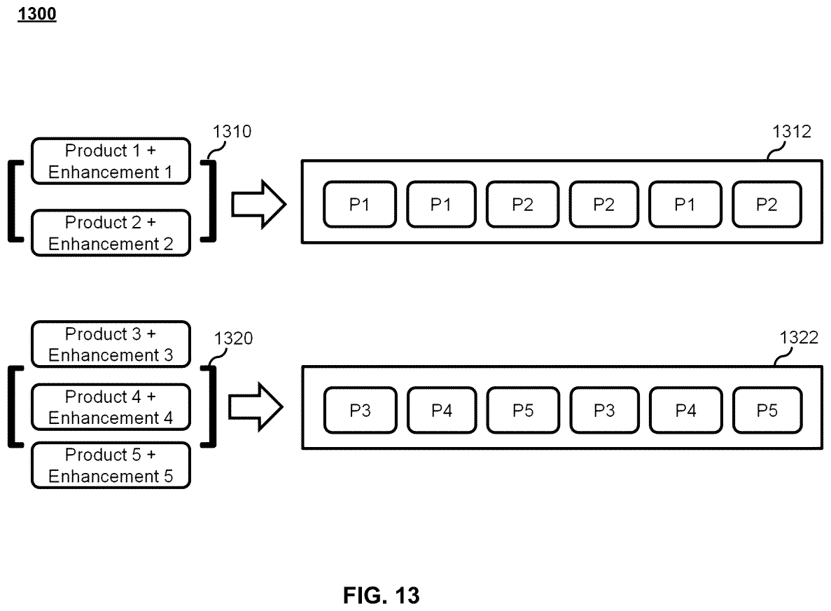

FIG. 13 illustrates an exemplary process 1300 for increasing diversity of item recommendation carousels, in accordance with some embodiments of the present teaching. In some embodiments, the process 1300 can be carried out by one or more computing devices, such as the item recommendation computing device 102 and/or the cloud-based engine 121 of FIG. 1. In some embodiments, the process 1300 illustrates a detailed process of the operation 570 performed by the item recommendation generator 450 for increasing diversity of item recommendation carousels.

In the example shown in FIG. 13, each query entity is a product, and each enhanced query is formed based on a product and a corresponding enhancement. When multiple query entities are collapsed into a single group, the top results from the search index for each product can be used to extract the most relevant items. The items relevant to each product or each entity may be shown equally to ensure equal representation of different entities in a carousel, to increase product diversity in the carousel.

For example, the group 1310 includes two products P1 and P2. Accordingly, the item recommendation carousel 1312 corresponding to the group 1310 includes items extracted based on P1 and P2 respectively, e.g. based on the operations 520 to 564 in FIG. 5. Items extracted for a same product may be related to different versions or variants of the same product, e.g. a product with different capacities, colors and/or sizes. But instead of putting all items extracted for P1 together before all items extracted for P2, or the other way around, the item recommendation carousel 1312 alternates or interleaves the items extracted for P1 and P2 to increase product diversity in the item recommendation carousel 1312.

Similarly, the group 1320 includes three products P3, P4 and P5. Accordingly, the item recommendation carousel 1322 corresponding to the group 1320 includes items extracted based on P3, P4 and P5 respectively, e.g. based on the operations 520 to 564 in FIG. 5. But instead of putting all items extracted for one or each of the products P3, P4 and P5 together, the item recommendation carousel 1322 alternates or interleaves the items extracted for P3, P4 and P5 to increase product diversity in the item recommendation carousel 1322.

In some embodiments, if a carousel only has one product type, the system can recommend similar items of different product types, e.g. based on the operations 550 to 564 in FIG. 5 with a target for different product types. This can ensure a healthy number of distinct product types in each carousel, to increase product type diversity of a carousel. When there are multiple product types present within a single carousel, the system can be rearrange the product types so that an overall diversity of the carousel is improved to avoid putting too many items of the same product type together.

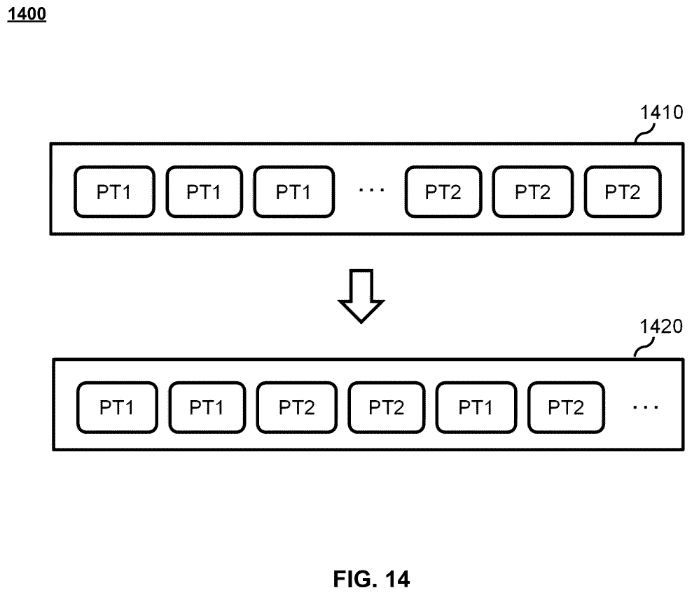

FIG. 14 illustrates another exemplary process 1400 for increasing diversity of item recommendation carousels, in accordance with some embodiments of the present teaching. In some embodiments, the process 1400 can be carried out by one or more computing devices, such as the item recommendation computing device 102 and/or the cloud-based engine 121 of FIG. 1. In some embodiments, the process 1400 illustrates a detailed process of the operation 570 performed by the item recommendation generator 450 for increasing diversity of item recommendation carousels.

In the example shown in FIG. 14, each query entity is a product type, and a carousel 1410 will be transformed to a carousel 1420 based on the process 1400 of product type diversification. In this example, each of the carousel 1410 and the carousel 1420 includes two product types PT1 and PT2. Items may be extracted based on PT1 and PT2 (as two query entities) respectively, e.g. based on the operations 520 to 564 in FIG. 5. In the carousel 1410 before product type diversification, all items extracted for PT1 are placed all together before all items extracted for PT2. In contrast, in the carousel 1420 after product type diversification, items extracted for PT1 and PT2 are alternatively placed. As such, the carousel 1420 has a higher product type diversity than the carousel 1410.

In some embodiments, the system can generate a title for each carousal shown to the customer. In some examples, the system can analyze the product types present within a carousal, and then send information about all of the product types to an LLM, e.g. the language model 415, to generate an appropriate carousal title that can represent all of the product types.

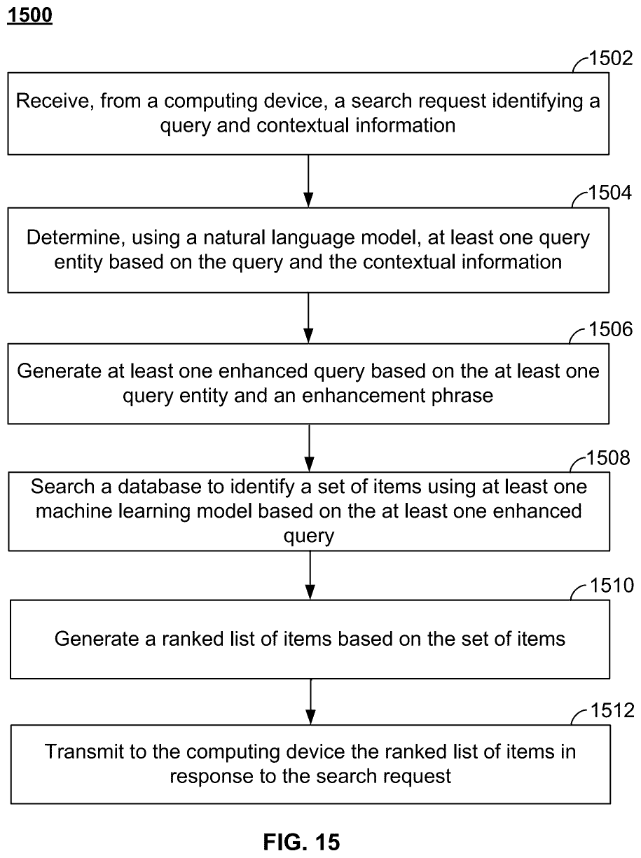

FIG. 15 is a flowchart illustrating an exemplary method 1500 for performing product search based on conversations with customers, in accordance with some embodiments of the present teaching. In some embodiments, the method 1500 can be carried out by one or more computing devices, such as the item recommendation computing device 102 and/or the cloud-based engine 121 of FIG. 1. Beginning at operation 1502, a search request identifying a query and contextual information is received from a computing device. At operation 1504, at least one query entity is determined using a natural language model based on the query and the contextual information. At operation 1506, at least one enhanced query is generated based on the at least one query entity and an enhancement phrase. At operation 1508, a database is searched to identify a set of items using at least one machine learning model based on the at least one enhanced query data. At operation 1510, a ranked list of items is generated based on the set of items. The ranked list of items is transmitted at operation 1512 to the computing device in response to the search request.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMS, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a processor; and
a non-transitory memory storing instructions, that when executed, cause the processor to:
receive a search request identifying a query and contextual information,
determine, using a natural language model, at least one query entity based on the query and the contextual information,
generate at least one enhanced query based on the at least one query entity and an enhancement phrase,
search a database to identify a set of items using at least one machine learning model based on the at least one enhanced query,
generate at least one ranked list of items based on the set of items, and
transmit the at least one ranked list of items to a computing device.

2. The system of claim 1, wherein the at least one enhanced query is generated based on:
generating the enhancement phrase based on the query; and
concatenating each query entity of the at least one query entity with the enhancement phrase to generate the at least one enhanced query.

3. The system of claim 2, wherein generating the enhancement phrase comprises:
generating an embedding vector representing the query based on the query and the contextual information;
comparing the embedding vector with embedding vectors representing a plurality of product types respectively to compute a similarity score for each respective product type of the plurality of product types, wherein the similarity score indicates a degree of similarity between the query and the respective product type;
ranking the plurality of product types based on their respective similarity scores;
determining, based on the ranking and a threshold, one or more product type names of a subset of the plurality of product types;
identifying intersecting word tokens between the query and the one or more product type names; and
selecting at least one intersecting word token from the identified intersecting word tokens to generate the enhancement phrase.

4. The system of claim 2, wherein generating the enhancement phrase comprises:
inputting textual information of the query and the at least one query entity into the natural language model to generate a model output based on prompt engineering; and
generating the enhancement phrase based on the model output.

5. The system of claim 1, wherein the database is searched based on:
for each enhanced query of the at least one enhanced query:
encoding the enhanced query to an enhanced query embedding;
comparing the enhanced query embedding with a set of stored embeddings in the database based on nearest neighbor indices created for the set of stored embeddings, wherein each of the set of stored embeddings represents a respective query commonly searched by users;
determining, among the set of stored embeddings, at least one closest embedding to the enhanced query embedding based on the comparing;
identifying at least one corresponding query represented by the at least one closest embedding;
determining, using a predictive model, a list of items for the enhanced query, wherein the list of items are items most likely to be purchased by customers of a retailer after the customers submit the at least one corresponding query, wherein the predictive model is trained based on customer transaction patterns representing customer preferences associated with the retailer; and
identifying the set of items based on the list of items determined for each respective enhanced query of the at least one enhanced query.

6. The system of claim 1, wherein:
the at least one query entity comprises a plurality of query entities, each of which corresponds to: a product, a product type, a product category, a product family, or a product department;
the plurality of query entities are grouped into a plurality of carousel groups, each of which corresponds to a carousel of items to be presented via a user interface in response to the search request; and
the at least one ranked list of items is generated by generating a ranked list of items based on the carousel of items for each carousel group of the plurality of carousel groups.

7. The system of claim 6, wherein the ranked list of items for each carousel group is generated based on:
determining the carousel of items based on the carousel group and the set of items; and
ranking the carousel of items to generate the ranked list of items based on at least one of:
an equal representation of different query entities in the carousel group,
an increase of product type diversity in the carousel group, or
an equal representation of different product types in the carousel group.

8. The system of claim 6, wherein the instructions, when executed, further cause the processor to:
generate a carousel title for each respective carousel group to represent all product types of the carousel of items for the respective carousel group; and
transmit to the computing device the carousel title to be presented together with the carousel of items for the respective carousel group.

9. A computer-implemented method, comprising:
receiving a search request identifying a query and contextual information;
determining, using a natural language model, at least one query entity based on the query and the contextual information;
generating at least one enhanced query based on the at least one query entity and an enhancement phrase;
searching a database to identify a set of items using at least one machine learning model based on the at least one enhanced query;
generating at least one ranked list of items based on the set of items; and
transmitting the at least one ranked list of items to a computing device.

10. The computer-implemented method of claim 9, wherein generating the at least one enhanced query comprises:
generating the enhancement phrase based on the query; and
concatenating each query entity of the at least one query entity with the enhancement phrase to generate the at least one enhanced query.

11. The computer-implemented method of claim 10, wherein generating the enhancement phrase comprises:
generating an embedding vector representing the query based on the query and the contextual information;
comparing the embedding vector with embedding vectors representing a plurality of product types respectively to compute a similarity score for each respective product type of the plurality of product types, wherein the similarity score indicates a degree of similarity between the query and the respective product type;
ranking the plurality of product types based on their respective similarity scores;
determining, based on the ranking and a threshold, one or more product type names of a subset of the plurality of product types;
identifying intersecting word tokens between the query and the one or more product type names; and
selecting at least one intersecting word token from the identified intersecting word tokens to generate the enhancement phrase.

12. The computer-implemented method of claim 10, wherein generating the enhancement phrase comprises:
inputting textual information of the query and the at least one query entity into the natural language model to generate a model output based on prompt engineering; and
generating the enhancement phrase based on the model output.

13. The computer-implemented method of claim 9, wherein searching the database comprises:
for each enhanced query of the at least one enhanced query:
encoding the enhanced query to an enhanced query embedding;
comparing the enhanced query embedding with a set of stored embeddings in the database based on nearest neighbor indices created for the set of stored embeddings, wherein each of the set of stored embeddings represents a respective query commonly searched by users;
determining, among the set of stored embeddings, at least one closest embedding to the enhanced query embedding based on the comparing;
identifying at least one corresponding query represented by the at least one closest embedding;
determining, using a predictive model, a list of items for the enhanced query, wherein the list of items are items most likely to be purchased by customers of a retailer after the customers submit the at least one corresponding query, wherein the predictive model is trained based on customer transaction patterns representing customer preferences associated with the retailer; and
identifying the set of items based on the list of items determined for each respective enhanced query of the at least one enhanced query.

14. The computer-implemented method of claim 9, wherein:
the at least one query entity comprises a plurality of query entities, each of which corresponds to: a product, a product type, a product category, a product family, or a product department;
the plurality of query entities are grouped into a plurality of carousel groups, each of which corresponds to a carousel of items to be presented via a user interface in response to the search request; and
generating the at least one ranked list of items comprises generating a ranked list of items based on the carousel of items for each carousel group of the plurality of carousel groups.

15. The computer-implemented method of claim 14, wherein generating the ranked list of items for each carousel group comprises:
determining the carousel of items based on the carousel group and the set of items; and
ranking the carousel of items to generate the ranked list of items based on at least one of:
an equal representation of different query entities in the carousel group,
an increase of product type diversity in the carousel group, or
an equal representation of different product types in the carousel group.

16. The computer-implemented method of claim 14, further comprising:
generating a carousel title for each respective carousel group to represent all product types of the carousel of items for the respective carousel group; and
transmitting to the computing device the carousel title to be presented together with the carousel of items for the respective carousel group.

17. A non-transitory computer readable medium having instructions stored thereon, wherein the instructions, when executed by at least one processor, cause at least one device to perform operations comprising:
receiving a search request identifying a query and contextual information;
determining, using a natural language model, at least one query entity based on the query and the contextual information;
generating at least one enhanced query based on the at least one query entity and an enhancement phrase;
searching a database to identify a set of items using at least one machine learning model based on the at least one enhanced query;
generating at least one ranked list of items based on the set of items; and
transmitting the at least one ranked list of items to a computing device.

18. The non-transitory computer readable medium of claim 17, wherein generating the at least one enhanced query comprises:
generating the enhancement phrase based on the query; and
concatenating each query entity of the at least one query entity with the enhancement phrase to generate the at least one enhanced query.

19. The non-transitory computer readable medium of claim 18, wherein generating the enhancement phrase comprises:
generating an embedding vector representing the query based on the query and the contextual information;
comparing the embedding vector with embedding vectors representing a plurality of product types respectively to compute a similarity score for each respective product type of the plurality of product types, wherein the similarity score indicates a degree of similarity between the query and the respective product type;
ranking the plurality of product types based on their respective similarity scores;
determining, based on the ranking and a threshold, one or more product type names of a subset of the plurality of product types;
identifying intersecting word tokens between the query and the one or more product type names; and
selecting at least one intersecting word token from the identified intersecting word tokens to generate the enhancement phrase.

20. The non-transitory computer readable medium of claim 18, wherein generating the enhancement phrase comprises:
inputting textual information of the query and the at least one query entity into the natural language model to generate a model output based on prompt engineering; and
generating the enhancement phrase based on the model output.
